(19) United States
(12) Patent Application Publication
(10) Pub. No.: US 2023/0030398 A1
(43) Pub. Date: Feb. 2, 2023

(54) Yogurt Composition

(71) Applicant: General Mills, Inc., Minneapolis, MN (US)

(72) Inventors: Roy Bechtold, St. Louis Park, MN (US); Rachel Eaton, Minneapolis, MN (US); Luke Hazlett, Oshawa (CA); Anna Veynberger, Toronto (CA)

(73) Assignee: General Mills, Inc., Minneapolis, MN (US)

(21) Appl. No.: 17/872,085

(22) Filed: Jul. 25, 2022

Related U.S. Application Data
(60) Provisional application No. 63/226,890, filed on Jul. 29, 2021.

(51) Int. Cl. A23C 9/123; A23C 19/09; A23C 9/13; A23C 9/15

(52) U.S. Cl. CPC A23C 9/1232; A23C 19/09; A23C 9/1307; A23C 9/123; A23C 9/1512

(57) ABSTRACT

A yogurt core is described that contains yogurt or a yogurt analog, cream cheese or a cream cheese analog, and dairy-derived powder or dairy-free powder. A yogurt core provides a less tart flavor due to a pH above 4.6, yet remains safe over an extended refrigerated shelf life due to a water activity of less than 0.92. A yogurt core can be enrobed to provide a hand-holdable yogurt-containing snack.

### CROSS REFERENCE TO RELATED APPLICATIONS

This application claims the benefit of U.S. Provisional Patent Application Ser. No. 63/226,890, which was filed on Jul. 29, 2021 and titled “Yogurt Composition”. The entire content of this application is incorporated by reference.

### BACKGROUND

Consumers are increasingly looking for new and interesting eating experiences. As consumers become more aware of the need for more nutritional foods, while still desiring enjoyable eating experiences, a new challenge has been to produce foods that fulfill both needs.

### SUMMARY

The present disclosure relates to food products that contain a yogurt core that has an extended refrigerated shelf life.

A food product having a yogurt core is provided herein. A food product provided herein can be stable at 4° C. for at least 30 days. A food product provided herein can include a fat-based coating enrobing the yogurt core.

In some embodiments, a provided food product includes a yogurt core having a water activity of less than 0.92 and a pH above 4.6, where the yogurt core consists of yogurt in an amount of about 28% to about 40% by weight of the yogurt core; cream cheese in an amount of about 60% to about 90% by weight of the yogurt, wherein the combined amount of yogurt and cream cheese comprises about 45% to about 60% by weight of the yogurt core; dairy-derived powder in an amount of about 14% to about 25% by weight of the yogurt core, wherein the amount of dairy-derived powder is included in an amount of from about 55% to about 75% by weight of the yogurt; sugar in an amount of 10% to 20% by weight of the yogurt core; and other ingredients in an amount of up to 15% by weight of the yogurt core.

In some embodiments, a provided food product includes a yogurt core having a water activity of less than 0.92 and a pH above 4.6 and below 7, where the yogurt core consists of a strained yogurt in an amount of about 28% to about 32% by weight of the yogurt core; cream cheese in an amount of about 60% to about 70% by weight of the yogurt, wherein the combined amount of yogurt and cream cheese comprises about 45% to about 55% by weight of the yogurt core; dairy-derived powder in an amount of about 18% to about 24% by weight of the yogurt core, wherein the amount of dairy-derived powder is included in an amount of from about 65% to about 70% by weight of the strained yogurt; sugar in an amount of 15% to 18% by weight of the yogurt core, wherein at least a portion of the sugar comprises fructose; and other ingredients in an amount of about 8% to about 12% by weight of the yogurt core.

In some embodiments, a provided food product includes a yogurt core having a water activity of less than 0.92 and a pH above 4.6, where the yogurt core consists of yogurt, or a yogurt analog, in an amount of about 28% to about 40% by weight of the yogurt core; cream cheese, or a cream cheese analog, in an amount of about 60% to about 90% by weight of the yogurt, wherein the combined amount of yogurt and cream cheese comprises about 45% to about 60% by weight of the yogurt core; dairy-derived powder in an amount of about 14% to about 25% by weight of the yogurt core, wherein the amount of dairy-derived powder is included in an amount of from about 55% to about 75% by weight of the yogurt; sugar in an amount of 10% to 20% by weight of the yogurt core; and other ingredients in an amount of up to 15% by weight of the yogurt core.

In some embodiments, a provided food product includes a yogurt core having a water activity of less than 0.92 and a pH above 4.6, where the yogurt core consists of yogurt, or a yogurt analog, in an amount of about 28% to about 40% by weight of the yogurt core; cream cheese, or a cream cheese analog, in an amount of about 60% to about 90% by weight of the yogurt, wherein the combined amount of yogurt and cream cheese comprises about 45% to about 60% by weight of the yogurt core; dairy-derived powder in an amount of about 14% to about 25% by weight of the yogurt core, wherein the amount of dairy-derived powder is included in an amount of from about 55% to about 75% by weight of the yogurt; a sweetening system in an amount of up to 20% by weight of the yogurt core; and other ingredients in an amount of up to 15% by weight of the yogurt core. In some embodiments, a yogurt core that contains a sweetening system can contain less than 10% sugar by weight of the yogurt core. In some embodiments, a sweetening system can include at least one of allulose, inulin, and erythritol. In some embodiments, a sweetening system can include a high intensity sweetener.

In some embodiments, a provided food product includes a yogurt core having a water activity of less than 0.92 and a pH above 4.6, where the yogurt core is dairy-free and/or vegan and where the yogurt core consists of a yogurt analog, in an amount of about 28% to about 40% by weight of the yogurt core; a cream cheese analog, in an amount of about 60% to about 90% by weight of the yogurt analog, wherein the combined amount of yogurt analog and cream cheese analog comprises about 45% to about 60% by weight of the yogurt core; dairy-free powder in an amount of about 14% to about 25% by weight of the yogurt core, wherein the amount of dairy-free powder is included in an amount of from about 55% to about 75% by weight of the yogurt analog; sugar in an amount of 10% to 20% by weight of the yogurt core; and other ingredients in an amount of up to 15% by weight of the yogurt core.

In some embodiments, a provided food product includes a yogurt core having a water activity of less than 0.92 and a pH above 4.6, where the yogurt core is dairy-free and/or vegan and where the yogurt core consists of a yogurt analog, in an amount of about 28% to about 40% by weight of the yogurt core; a cream cheese analog, in an amount of about 60% to about 90% by weight of the yogurt analog, wherein the combined amount of yogurt analog and cream cheese analog comprises about 45% to about 60% by weight of the yogurt core; dairy-free powder in an amount of about 14% to about 25% by weight of the yogurt core, wherein the amount of dairy-free powder is included in an amount of from about 55% to about 75% by weight of the yogurt analog; a sweetening system in an amount of up to 20% by weight of the yogurt core; and other ingredients in an amount of up to 15% by weight of the yogurt core. In some embodiments, a yogurt core that contains a sweetening system can contain less than 10% sugar by weight of the yogurt core. In some embodiments, a sweetening system can include at least one of allulose, inulin, and erythritol. In some embodiments, a sweetening system can include a high intensity sweetener.

In some embodiments, the pH of a yogurt core is less than 7.

In some embodiments, sugar in a yogurt core can include fructose. In some embodiments, sugar in a yogurt core can be at least 50% by weight fructose.

In some embodiments, a yogurt core can include strained yogurt or yogurt analog.

In some embodiments, dairy-derived powder can include yogurt powder, calcium caseinate, and/or whey protein concentrate.

In some embodiments, dairy-free powder can include a yogurt analog powder, casein derived from microbial fermentation or plant synthesis, and/or whey protein derived from microbial fermentation or plant synthesis.

In some embodiments, other ingredients in a yogurt core can include a starch, a gum, and/or a water activity modifier, such as glycerol and/or maltodextrin.

These and various other features and advantages will be apparent from a reading of the following detailed description.

### BRIEF DESCRIPTION OF DRAWINGS

FIG. 1 shows two embodiments of a food product that includes a yogurt core and a fat-based coating enrobing the yogurt core. Each of the shown embodiments is in the form of a snack bar and has been broken to show a yogurt core inside a fat-based coating.

### DETAILED DESCRIPTION

Many consumers enjoy eating yogurt for a number of reasons. However, some consumers are turned off by the distinct tartness of yogurt imparted by a low pH, typically 4.6 or lower, resulting from fermentation. Nonetheless, the creamy texture of yogurt and nutritional benefits are attractive for consumers who want to be more health-conscious in their eating habits, even while having an indulgent eating experience.

It was discovered, and is described herein, that a unique combination of ingredients can be combined at specific ratios to achieve an indulgent yogurt-based food product that can be eaten in solid form while maintaining a creamy yogurt-like mouthfeel and achieving a unique flavor. In particular, a food product is described herein that has an extended shelf life at refrigerated temperatures (e.g., about 40 to 45° F.), and includes a yogurt core that combines yogurt with cream cheese, and at least one dairy-derived powder to achieve a texture that is recognizable as yogurt while having a reduced tartness. A food product that includes a yogurt core described herein has a benefit of being able to adjust the tartness of the yogurt core because it has a pH above 4.6, yet remains safe over shelf life because the water activity of the yogurt core is less than 0.92, without resulting in a dry or crumbly texture.

A food product provided herein generally includes a yogurt core that is enrobed by a coating, such as a fat-based coating. A food product has an extended shelf life at refrigerated temperatures. That is, a food product provided herein is stable at 4° C. for at least 30 days (e.g., at least 45 days, or at least 60 days). In some embodiments, a food product provided herein can be frozen and thawed without significantly affecting its texture or appearance. Freeze-thaw stability can be useful in a product provided herein to allow for storage and/or transport in a frozen state prior to thawing for sale to consumers at refrigerated temperature.

A yogurt core suitable for a food product provided herein includes yogurt, cream cheese, and dairy-derived powder. In some embodiments, a yogurt core can consist of yogurt, cream cheese, dairy-derived powder, sugar, and up to 15% by weight other ingredients.

A yogurt core has a pH above 4.6 (e.g., above 4.6 and less than 7). To ensure that a food product provided herein remains safe to eat over an extended shelf life at refrigerated temperatures despite a pH over 4.6, a suitable yogurt core has a water activity of less than 0.92.Preferably, a yogurt core has a water activity of about 0.85 to less than 0.92, or about 0.87 to 0.89, to provide a creamy and/or smooth texture of the yogurt core. In some cases, a water activity of less than 0.85 can result in a texture that is perceived as gummy, chalky, dry, sticky, and/or gritty.

Yogurt can be included in a yogurt core in an amount of about 28% to about 40% (e.g., about 28% to about 35%, or about 28% to about 32%) by weight of the yogurt core. Yogurt can impart a creamy texture to a yogurt core and a yogurt flavor.

Any yogurt can be used in a yogurt core provided herein. Particularly suitable is a strained yogurt, such as a Greek-style yogurt, which can have a higher milk solids concentration than some other yogurt types to facilitate formulating to achieve an overall water activity of less than 0.92 in a yogurt core and/or achieve a more solid structure of a yogurt core. It is to be understood, however, that a yogurt core can include a yogurt that is not strained and still achieve the desired pH and water activity of the yogurt core. In some cases, a yogurt suitable for use can have a moisture content of about 80% to 88%.

Preferably, a yogurt included in a yogurt core comprises a yogurt that meets one or more legal definition of a yogurt (e.g., 21 U.S. § 131.200, 21 U.S. § 131.203, 21 U.S. § 131.206, and/or equivalents in other countries). However, it is contemplated that some yogurt analogs, such as a yogurt-like fermented food made from dairy-derived ingredients, plant-derived ingredients, and/or microbe-derived ingredients may be suitable for use in a food provided herein. As used herein, a yogurt analog can be used in a similar manner to a yogurt.

In some embodiments, yogurt included in a yogurt core can contribute a live an active culture to a yogurt core. A live and active bacteria culture can include any appropriate lactic acid bacteria, such as one or a combination of Streptococcus thermophilus and Lactobacillus delbrueckii subspecies bulgaricus. In addition, or alternatively, a live and active bacterial culture can include Lactobacillus species (e.g., Lactobacillus lactis, Lactobacillus acidophilus), Lactococcus species (e.g., Lactococcus lactis, Lactococcus lactis subsp. lactis biovar. diacetyllactis, Lactococcus lactis subsp. cremoris), Streptococcus species (e.g., Streptococcus salivarius sub sp. thermophilus, Streptococcus lactis var. bollandicus, Streptococcus taette), Bifidobacterium species (e.g., Bifidobacterium lactis), and the like, and combinations thereof.

A yogurt core can include cream cheese in an amount of about 60% to about 90% (e.g., about 60% to about 80%, about 60% to about 75%, or about 60% to about 70%) by weight of the yogurt that's included in the yogurt core. Cream cheese included in this range relative to yogurt content in a yogurt core can combine with the yogurt to achieve a surprising reduction of water activity and reduced tartness, while still maintaining creaminess and an overall flavor that are typical of yogurt. Too little cream cheese relative to yogurt can result in a yogurt core that requires addition of dairy-derived powder, sugar, and/or other ingredients in amounts that negatively affect texture and/or flavor in order to achieve a desired water activity. On the other hand, too much cream cheese relative to yogurt can result in a flavor and/or texture that no longer resembles yogurt and/or becomes thick and crumbly.

In some embodiments, cream cheese can be included in a yogurt core in an amount of about 16% to about 24% (e.g., about 18% to about 22%) by weight of the yogurt core.

Preferably, a cream cheese included in a yogurt core comprises a cream cheese that meets one or more legal definition of a cream cheese (e.g., 21 U.S. § 133.133, low fat or fat-free foods that otherwise meet 21 U.S. § 133.133, and/or equivalents in other countries). However, it is contemplated that some cream cheese analogs, such as a cream cheese-like food made from dairy-derived ingredients, plant-derived ingredients, and/or microbe-derived ingredients may be suitable for use in a food provided herein. As used herein, a cream cheese analog can be used in a similar manner to a cream cheese. In some cases, a cream cheese or cream cheese analog suitable for use herein can have a moisture content of about 45% to 55%.

A yogurt core can contain a combined amount of yogurt and cream cheese that comprises about 45% to about 60% (e.g., about 45% to about 55%, or about 48% to about 52%) of the weight of the yogurt core.

A yogurt core described herein can include dairy-derived powder in an amount of about 14% to about 25% (e.g., about 18% to about 24%, or about 20% to about 22%) by weight of the yogurt core. In some embodiments, dairy-derived powder can be included in an amount of about 55% to about 75% (e.g., about 65% to about 70%) by weight of yogurt in a yogurt core. Dairy-derived powder included in this range relative to yogurt content in a yogurt core can combine with the yogurt and with cream cheese to achieve a sufficiently low water activity (i.e., less than 0.92) to ensure that a food containing the yogurt core remains safe to eat over an extended refrigerated shelf life. Too little dairy-derived powder relative to yogurt can result in a yogurt core that cannot achieve a desired water activity.

Too much dairy-derived powder relative to yogurt can result in a flavor and/or texture that no longer resembles yogurt and/or becomes dry and crumbly.

As used herein, the term “dairy-derived powder” refers to a dry, powdered ingredient derived from milk or a dairy food. Suitable dairy-derived powders include, without limitation, yogurt powder, milk powder, calcium caseinate, whey protein concentrate, whey protein isolate, milk protein concentrate, cream powder, or any combination thereof. Caseinates, such as calcium caseinate, can be particularly useful for reducing water activity without imparting significant chalkiness to a yogurt core. Whey protein ingredients (e.g, whey protein concentrate, or whey protein isolate) can be useful for increasing protein content in a yogurt core. Yogurt powder, milk powder, cream cheese powder, and the like can be useful for contributing to a desired flavor profile of a yogurt core.

It is contemplated that, in some embodiments, dairy-derived powders may be substituted with suitable dairy-free and/or vegan powders. For example, a casein or whey powder derived from microbial fermentation and/or plant synthesis can be substituted for a dairy-derived caseinate powder or dairy-derived whey powder, respectively. In some embodiments, such ingredients can be suitably combined with a yogurt analog and a cream cheese analog, each made from plant-derived ingredients and/or microbe-derived ingredients, to produce a dairy-free and/or vegan food product.

In some embodiments, a yogurt core can include sugar. Sugar in a yogurt core can be useful to impart sweetness and/or adjust water activity of the yogurt core without imparting an undesirable texture (e.g., dryness) or flavor. As used herein, sugar in a yogurt core refers to added sugar, and not sugars native to yogurt, cream cheese, or a dairy-derived powder.

Any sugar, such as powdered or granulated sucrose, fructose, glucose, or sugar syrups (e.g., honey, corn syrup, or the like), fruit powders or concentrates, or any combination thereof, can be used in a yogurt core. Fructose alone, or in combination with other sugars, can be particularly useful for contributing to a desired water activity. In some embodiments, sugar content in a yogurt core can include fructose in an amount of at least 30% (e.g., at least 40%, or at least 50%) by weight of the sugar content.

Sugar can be included in a yogurt core in an amount that is sufficient to achieve a desired sweetness and/or water activity. For example, sugar can be included in an amount of about 10% to about 20% (e.g., about 15% to about 18%) by weight of a yogurt core.

In some embodiments, a sweetening system that includes allulose and/or one or more non-sugar ingredient can be included in a yogurt core. A sweetening system can be used together with sugar and/or to replace sugar in-part or entirely. A sweetening system can include one or more ingredient that provides at least some of the sweetness and bulk that a sugar would otherwise contribute. For example, a yogurt core can include a sweetening system in an amount of up to 20% (e.g., about 5% to about 20%, about 10% to about 20%, or about 15% to about 18%) by weight of the yogurt core, where the sweetening system includes, for example, allulose, a sugar alcohol (e.g., erythritol, maltitol, or the like), a fiber (e.g., inulin, or the like), and/or a high intensity sweetener (e.g., stevia extract, sucralose, or the like) to replace 0-100% (e.g., at least 50%, at least 80%, or 100%) of a sugar in the yogurt core. In some embodiments, a yogurt core that contains a sweetening system can contain sugar in an amount of less than 10% (e.g., less than 8%, less than 5%, or 0%) by weight of the yogurt core.

In some embodiments, a yogurt core described herein can include one or more other ingredient than those listed above in an amount of up to 15% (e.g., up to 12%, or from about 8% to about 12%) by weight of the yogurt core. Examples of other ingredients include, without limitation, a water activity modifier (e.g., a polyol, maltodextrin, or the like), a starch, a gum, a flavorant, a vitamin or mineral, an organic acid, a preservative, a colorant, or any combination thereof, to achieve a desired flavor, texture, or appearance.

In some embodiments, other ingredients included in a yogurt core can include a starch and/or a gum to contribute to structure and/or freeze-thaw stability. In some embodiments, starch can be included in a yogurt core in an amount of up to 4% by weight of the yogurt core. In some embodiments, a gum can be included in a yogurt core in an amount of up to 0.5% by weight of the yogurt core.

In some embodiments, other ingredients included in a yogurt core can include a water activity modifier, such as a polyol (e.g., glycerol) or maltodextrin. In some cases, a polyol and/or maltodextrin can contribute as a bulking agent and/or thickener. In some embodiments, a water activity modifier can be included in a yogurt core in an amount of up to 8% by weight of the yogurt core.

Although a yogurt core need not contain a preservative to inhibit pathogen growth over an extended refrigerated shelf life due to having a water activity of less than 0.92, in some embodiments, a yogurt core can include a preservative (e.g., potassium sorbate) to inhibit yeast and/or mold growth over shelf life.

A yogurt core described herein can be made using any suitable method and equipment. For example, ingredients can be mixed, and a yogurt core can be formed using standard extrusion methods.

A yogurt core can be enrobed in a coating, such as a fat-based coating, to make a food product. In some embodiments, a yogurt core can be placed on a layer of a fat-based coating on a manufacturing surface, such as a conveyer belt, prior to being enrobed. Such a fat-based coating layer on a manufacturing surface can help prevent sticking of a yogurt core to the surface during manufacture. Suitable coatings include, for example, chocolate-based or yogurt-based compound coatings.

In some embodiments, a food product can be frozen after enrobing, which can ensure that the fat-based coating sets and that the food product is cooled to a temperature that enables safe storage and/or transportation.

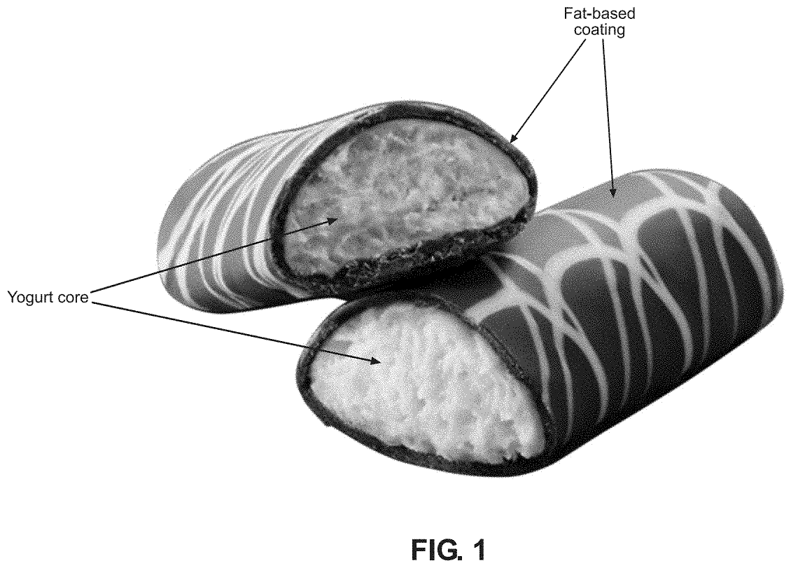

A food product including a yogurt core enrobed in a coating can be in any appropriate form, such as a snack bar or bite-sized pieces. Examples of a food product described herein in snack bar form are shown in FIG. 1.

A food product can be packaged using any appropriate packaging. A food product described herein can be packaged in a single serving or as multiple servings.

In some embodiments, a food product can be conveniently frozen for storage and/or distribution, before being held at refrigeration temperatures.

The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A food product, comprising:
a. a yogurt core having a water activity of less than 0.92 and a pH above 4.6, the yogurt core selected from:
i. Core A, consisting of:
a) yogurt in an amount of about 28% to about 40% by weight of the yogurt core;
b) cream cheese in an amount of about 60% to about 90% by weight of the yogurt, wherein the combined amount of yogurt and cream cheese comprises about 45% to about 60% by weight of the yogurt core;
c) dairy-derived powder in an amount of about 14% to about 25% by weight of the yogurt core, wherein the amount of dairy-derived powder is included in an amount of from about 55% to about 75% by weight of the yogurt;
d) sugar in an amount of 10% to 20% by weight of the yogurt core; and
e) other ingredients in an amount of up to 15% by weight of the yogurt core;
ii. Core B, consisting of:
a) a strained yogurt in an amount of about 28% to about 32% by weight of the yogurt core;
b) cream cheese in an amount of about 60% to about 70% by weight of the yogurt, wherein the combined amount of yogurt and cream cheese comprises about 45% to about 55% by weight of the yogurt core;
c) dairy-derived powder in an amount of about 18% to about 24% by weight of the yogurt core, wherein the amount of dairy-derived powder is included in an amount of from about 65% to about 70% by weight of the strained yogurt;
d) sugar in an amount of 15% to 18% by weight of the yogurt core, wherein at least a portion of the sugar comprises fructose; and
e) other ingredients in an amount of about 8% to about 12% by weight of the yogurt core;
iii. Core C, consisting of:
a) yogurt, or a yogurt analog, in an amount of about 28% to about 40% by weight of the yogurt core;
b) cream cheese, or a cream cheese analog, in an amount of about 60% to about 90% by weight of the yogurt, wherein the combined amount of yogurt and cream cheese comprises about 45% to about 60% by weight of the yogurt core;
c) dairy-derived powder in an amount of about 14% to about 25% by weight of the yogurt core, wherein the amount of dairy-derived powder is included in an amount of from about 55% to about 75% by weight of the yogurt;
d) sugar in an amount of 10% to 20% by weight of the yogurt core;
and e) other ingredients in an amount of up to 15% by weight of the yogurt core; and
iv. Core D, consisting of:
a) yogurt, or a yogurt analog, in an amount of about 28% to about 40% by weight of the yogurt core;
b) cream cheese, or a cream cheese analog, in an amount of about 60% to about 90% by weight of the yogurt, wherein the combined amount of yogurt and cream cheese comprises about 45% to about 60% by weight of the yogurt core;
c) dairy-derived powder in an amount of about 14% to about 25% by weight of the yogurt core, wherein the amount of dairy-derived powder is included in an amount of from about 55% to about 75% by weight of the yogurt;
d) a sweetening system in an amount of up to 20% by weight of the yogurt core; and
e) other ingredients in an amount of up to 15% by weight of the yogurt core;
v. Core E, consisting of:
a) a yogurt analog, in an amount of about 28% to about 40% by weight of the yogurt core;
b) a cream cheese analog, in an amount of about 60% to about 90% by weight of the yogurt analog, wherein the combined amount of yogurt analog and cream cheese analog comprises about 45% to about 60% by weight of the yogurt core;
c) dairy-free powder in an amount of about 14% to about 25% by weight of the yogurt core, wherein the amount of dairy-free powder is included in an amount of from about 55% to about 75% by weight of the yogurt analog;
d) sugar in an amount of 10% to 20% by weight of the yogurt core;
and e) other ingredients in an amount of up to 15% by weight of the yogurt core;
f) wherein Core E is dairy-free and/or vegan;
vi. Core F, consisting of:
a) a yogurt analog, in an amount of about 28% to about 40% by weight of the yogurt core;
b) a cream cheese analog, in an amount of about 60% to about 90% by weight of the yogurt analog, wherein the combined amount of yogurt analog and cream cheese analog comprises about 45% to about 60% by weight of the yogurt core;
c) dairy-free powder in an amount of about 14% to about 25% by weight of the yogurt core, wherein the amount of dairy-free powder is included in an amount of from about 55% to about 75% by weight of the yogurt analog;
d) a sweetening system in an amount of up to 20% by weight of the yogurt core; and
e) other ingredients in an amount of up to 15% by weight of the yogurt core f) wherein Core F is dairy-free and/or vegan; and
b. fat-based coating enrobing the yogurt core, wherein the food product is stable at 4° C. for at least 30 days.

2. The food product of claim 1, wherein the pH of the yogurt core is less than 7.

3. The food product of claim 1, wherein the sugar or the sweetening system comprises fructose.

4. The food product of claim 3, wherein the sugar comprises at least 50% by weight fructose.

5. The food product of claim 1, wherein the yogurt comprises a strained yogurt.

6. The food product of claim 1, wherein the dairy-derived powder comprises yogurt powder.

7. The food product of claim 1, wherein the dairy-derived powder comprises calcium caseinate.

8. The food product of claim 7, wherein the dairy-derived powder comprises yogurt powder, whey protein concentrate, and calcium caseinate.

9. The food product of claim 1, wherein the other ingredients comprise glycerol or maltodextrin.

10. The food product of claim 1, wherein the other ingredients comprise a starch or a gum.

11. The food product of claim 1, comprising Core E or Core F.

12. The food product of claim 11, wherein the dairy-free powder comprises a yogurt analog powder.

13. The food product of claim 11, wherein the dairy-free powder comprises a casein derived from microbial fermentation or plant synthesis.

14. The food product of claim 11, wherein the dairy-free powder comprises whey protein derived from microbial fermentation or plant synthesis.

15. The food of claim 1, wherein the yogurt core comprises Core D and contains less than 10% sugar by weight of the yogurt core.

16. The food of claim 1, wherein the yogurt core comprises Core D, and the sweetening system comprises at least one of allulose, inulin, and erythritol.

17. The food of claim 15, wherein the sweetening system comprises a high intensity sweetener.
